(19) United States
(12) Patent Application Publication
(10) Pub. No.: US 2026/0169726 A1
(43) Pub. Date: Jun. 18, 2026

(54) OVER-THE-AIR (OTA) SERVICE SYSTEM FOR VEHICLES AND METHOD THEREOF

(71) Applicants: Hyundai Motor Company, Seoul (KR); Kia Corporation, Seoul (KR)

(72) Inventors: Jihee YOON, Hwaseong-Si (KR); Haeyoung KWON, Hwaseong-Si (KR); Jongha MOON, Hwaseong-Si (KR)

(21) Appl. No.: 19/397,001

(22) Filed: Nov. 21, 2025

(30) Foreign Application Priority Data
Dec. 16, 2024 (KR) 10-2024-0187507

(51) Int. Cl. G06F 8/65; G06F 11/14; G06F 11/30; G06F 16/23; G07C 5/00

(52) U.S. Cl. CPC G06F 8/65; G06F 11/1433; G06F 11/302; G06F 16/23; G07C 5/008

(57) ABSTRACT

The OTA service system may obtain, from a plurality of vehicles, usage data indicating historical usage patterns, by a plurality of users, of vehicle infotainment systems of the plurality of vehicles; store, in a database, the usage data; determine, based on the usage data, user rankings, for each of a plurality of geographic areas, of the plurality of users; determine a priority user group including users, of the plurality of users, having highest user rankings based on centrality measure; determine a plurality of ranked functionalities of the vehicle infotainment systems to be updated over-the-air (OTA); perform, in order of the plurality of ranked functionalities, initial OTA updates on vehicle infotainment systems of a first group of vehicles, of the plurality of vehicles, that are associated with the priority user group; and monitor the first group of vehicles for occurrence of an error event.

### CROSS-REFERENCE TO RELATED APPLICATION

This application claims priority to and the benefit of Korean Patent Application No. 10-2024-0187507, filed in the Korean Intellectual Property Office on Dec. 16, 2024, the entire contents of which are incorporated herein by reference.

### TECHNICAL FIELD

The present disclosure relates to vehicle maintenance, and more particularly to an over-the-air (OTA) service system for vehicles and a method thereof.

### BACKGROUND

As connected cars capable of wireless communication become more widespread, more manufacturers are providing an over-the-air (OTA) service, for example, to update various aspects of the vehicles, such as software, firmware, data (e.g., navigational maps, etc), and so forth.

The OTA service is a technology that automatically updates software of an infotainment terminal or a controller embedded in a connected car (hereinafter, referred to as a vehicle) using wireless communication. The OTA service thus may offer improved convenience to customers over other software update methods such as wired communication or plugging in memory devices (e.g., Universal Serial Bus (USB) memory, SD card memory, etc.) to a vehicle.

As more mechanical components of a vehicle become replaced by electronic components and advanced information technology (IT) technologies develop, vehicles are also advancing to be beyond the means of transportation and gaining value as moving spaces for rest, relaxation, and leisure. In addition, a complex array of physical buttons for operating various vehicle functions are increasingly being integrated into centralized infotainment terminals.

In such an environment, more vehicle manufacturers are providing OTA update services to their customers (hereinafter referred to as users) for convenient use of the functions and contents of infotainment terminals in their vehicles.

However, even after conducting rigorous tests (e.g., alpha and/or beta tests) of a software update ahead of an OTA update to ensure convenience and safety of the users, introduction of errors or bugs into the new software update during the development cycle (e.g., modification, addition, and deletion in software) is always a possibility.

Therefore, there exists a need for a software update service capable of early detection of and rapid response to errors that may occur during an initial OTA update.

The matters described in the Background section are drafted to enhance the understanding of the background of the disclosure, and may include matters that are not already known to those of ordinary skill in the art to which this technology pertains.

### SUMMARY

The present disclosure attempts to provide an over-the-air (OTA) service system for vehicles and a method thereof capable of early detecting event occurrence by collecting infotainment use data of a customer vehicle, selecting a user cluster with a high ranking score as an OTA target group, and monitoring the initial OTA progress.

According to the present disclosure, a stable OTA service may be provided by performing the initial OTA by using a loyal user cluster that has a high understanding of the function of vehicle infotainment and actively uses the function as a target group, and early determining an event occurrence situation through monitoring.

In addition, the trial and error may be reduced and customer satisfaction may be improved when actually performing OTA by first providing an OTA update to a selected infotainment loyal user cluster and checking feedback accordingly.

In addition, the event occurrence time and range required for re-examination may be specified by dividing an OTA target function list into a plurality of OTA ranking function groups according to importance and sequentially performing the initial OTA.

According to one or more example embodiments of the present disclosure, an apparatus for a vehicle may include: a processor; and a memory storing at least one instruction that is configured, when executed by the processor communicating with the memory, to cause the apparatus to: obtain, from a plurality of vehicles, usage data indicating historical usage patterns, by a plurality of users, of vehicle infotainment systems of the plurality of vehicles; store, in a database, the usage data; determine, based on the usage data, user rankings, for each of a plurality of geographic areas, of the plurality of users; determine a priority user group including users, of the plurality of users, having highest user rankings based on centrality measure; determine a plurality of ranked functionalities of the vehicle infotainment systems to be updated over-the-air (OTA); perform, in order of the plurality of ranked functionalities, initial OTA updates on vehicle infotainment systems of a first group of vehicles, of the plurality of vehicles, that are associated with the priority user group; and monitor the first group of vehicles for occurrence of an error event. The plurality of ranked functionalities may be ranked based on priority

The at least one instruction may be configured, when executed by the processor communicating with the memory, to cause the apparatus to store the usage data by: obtaining, based on the usage data, at least one of: a data collection date, a data collection time, a user identifier, a network identifier, vehicle infotainment system functionality log information, or error information; and updating, based on the usage data, a table in the database.

The at least one instruction may be configured, when executed by the processor communicating with the memory, to cause the apparatus to determine the priority user group by: determining a first group of functionalities of the vehicle infotainment systems and a second group of functionalities of the vehicle infotainment systems.

The at least one instruction may be configured, when executed by the processor communicating with the memory, to cause the apparatus to determine the priority user group by: allocating scores of categorical variable data with respect to the first group of functionalities and the second group of functionalities.

The at least one instruction may be configured, when executed by the processor communicating with the memory, to cause the apparatus to allocate the scores by one of: performing a ranking-based score allocation with respect to the first group of functionalities and the second group of functionalities, or performing a frequency-based score allocation.

The at least one instruction may be configured, when executed by the processor communicating with the memory, to cause the apparatus to determine the priority user group by: determining, based on the usage data, user ranking distributions according to network centrality-based geographic areas; and analyzing, based on a Gaussian mixture model (GMM), the user rankings for each of the plurality of geographic areas.

The at least one instruction may be configured, when executed by the processor communicating with the memory, to cause the apparatus to determine the priority user group by: determining, based on the usage data, a node size for each of functions of the plurality of users and a function edge size for each of the plurality of users according to the plurality of geographic areas; and determining an importance score with respect to each node based on centrality measure.

The at least one instruction may be configured, when executed by the processor communicating with the memory, to cause the apparatus to determine the priority user group by: selecting the priority user group as an initial OTA target group.

The plurality of ranked functionalities may include: a first group of functionalities including monitoring-critical functionalities; a second group of functionalities including OTA main functionalities; and a third group of functionalities including OTA sub functionalities.

The least one instruction may be configured, when executed by the processor communicating with the memory, to cause the apparatus to perform the initial OTA updates by sequentially performing: a first initial OTA update of the first group of functionalities; a second initial OTA update of the second group of functionalities; and a third initial OTA update of the third group of functionalities.

The at least one instruction may be configured, when executed by the processor communicating with the memory, to further cause the apparatus to: send, based on the occurrence of the error event, a signal to an operator terminal.

According to one or more example embodiments of the present disclosure, a method performed by a computing device may include: obtaining, from a plurality of vehicles, usage data indicating historical usage patterns, by a plurality of users, of vehicle infotainment systems of the plurality of vehicles; storing, in a database, the usage data; determining, based on the usage data, user rankings, for each of a plurality of geographic areas, of the plurality of users; determining a priority user group including users, of the plurality of users, having highest user rankings based on centrality measure; determining a plurality of ranked functionalities of the vehicle infotainment systems to be updated over-the-air (OTA); and performing, in order of the plurality of ranked functionalities, initial OTA updates on vehicle infotainment systems of a first group of vehicles, of the plurality of vehicles, that are associated with the priority user group; and monitoring the first group of vehicles for an occurrence of an error event. The plurality of ranked functionalities may be ranked based on priority.

The plurality of ranked functionalities may include: a first group of functionalities including monitoring-critical functionalities; a second group of functionalities including OTA main functionalities; and a third group of functionalities including OTA sub functionalities.

Monitoring the first group of vehicles may include: performing a first initial OTA update of the first group of functionalities by using the priority user group as a target group; monitoring the first initial OTA update and determining whether the error event has occurred; and, based on the monitoring-critical functionalities affecting driving safety data or no log being loaded, re-inspecting a corresponding OTA functionality.

The method may further include, after completing the first initial OTA update without the occurrence of the error event: performing a second initial OTA update of the second group of functionalities by using the priority user group as the target group; monitoring the second initial OTA update and determining whether the error event has occurred; and, based on the OTA main functionalities affecting the driving safety data or no log being loaded, re-inspecting the corresponding OTA functionality.

The method may further include, after completing the second initial OTA update without the occurrence of the error event: performing a third initial OTA update of the third group of functionalities by using the priority user group as the target group; monitoring the third initial OTA update and determining whether the error event has occurred; and, based on the OTA sub functionalities affecting the driving safety data or no log being loaded, re-inspecting the corresponding OTA functionality.

The method may further include determining whether the error event has occurred by: based on the error event not occurring, completing the third initial OTA update and ending the initial OTA; and determining that a verification of the plurality of ranked functionalities has been completed and performing an OTA update on remaining users of the plurality of users.

### BRIEF DESCRIPTION OF THE DRAWINGS

FIG. 1 is a block diagram showing the configuration of an example over-the-air (OTA) service system for vehicles.

FIGS. 2A and 2B are graphs showing an example process of automated initial OTA user cluster selection.

FIG. 3 is a block diagram showing a configuration of an example OTA function group generation unit.

FIG. 4 is a flowchart showing an example OTA service method for vehicles.

FIG. 5 shows an example computing system.

### DETAILED DESCRIPTION

With reference to the attached drawings, one or more example embodiments of the disclosure will be described in detail below so that ordinary skilled in the art may easily implement the disclosure.

The terms used herein are for the purpose of describing example embodiment(s) only, and are not intended to limit the present disclosure. As used herein, singular forms are intended to also include plural forms unless the context clearly indicates otherwise. It will also be understood that the terms “comprises” and/or “comprising” when used herein, specify the presence of mentioned features, integers, steps, actions, elements and/or components, but do not exclude the presence or addition of one or more of other features, integers, steps, actions, elements, components, and/or groups thereof. As used herein, the term “and/or” includes any one or all combinations of the associated listed items.

Throughout the specification, the terms first, second, A, B, (a), (b), etc. may be used to describe various components, but the components should not be limited by the terms. These terms are only used to distinguish the component from other components, and the nature, sequence, or order of the component is not limited by the terms.

It will be understood through the specification that when a component is referred to as being “connected to” or “coupled to” another component, it may be connected or coupled to the other component or intervening components may be present. In contrast, when a component is referred to as being “directly connected to” or “directly coupled to” another component, there are no intervening components present.

For purposes of the present application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein. One or more features associated with autonomous driving control may be activated based on configured autonomous driving control setting(s) (e.g., based on at least one of: an autonomous driving classification, a selection of an autonomous driving level for a vehicle, etc.).

Based on one or more features (e.g., selecting candidates for and performing OTA updates on vehicles) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., selecting candidates for and performing OTA updates on vehicles) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., selecting candidates for and performing OTA updates on vehicles) described herein.

Minimum risk maneuver (MRM) operation(s) may also be controlled, for example, based on one or more features (e.g., selecting candidates for and performing OTA updates on vehicles) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., selecting candidates for and performing OTA updates on vehicles) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane.

The driving control apparatus may identify a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

An autonomous driving level and/or autonomous driving activation/deactivation may also be controlled, for example, based on one or more features (e.g., selecting candidates for and performing OTA updates on vehicles) described herein. A driving control apparatus may perform an autonomous driving level control (e.g., a change of an autonomous driving level, a change of a required user attentiveness, etc.) or cause deactivation of an autonomous driving operation. For example, by changing the required user attentiveness, the driver may be required to place his/her hands on the driving wheel more often (e.g., at least once in a threshold time period, such as five second, 30 seconds, 1 minute, etc.). By changing the required user attentiveness, the driver may be required to look ahead more often (e.g., at least once in a threshold time period, such as five second, 30 seconds, 1 minute, etc.). By changing the autonomous driving level, one or more video contents may not be displayed on a display of the vehicle.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., selecting candidates for and performing OTA updates on vehicles) described herein.

An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, driver warning control, autonomous driving operational design domain (ODD), engaging and/or disengaging an autonomous driving mode, etc.). For example, the operation control may be performed and/or altered based on an OTA updates on a vehicle.

Throughout the specification, the terms used are for the purpose of describing example embodiment(s) only and is not intended to limit the present disclosure. The singular expression includes the plural expression unless the context clearly dictates otherwise.

Additionally, it is understood that one or more of the methods below or aspects thereof may be executed by at least one or more controllers. The term “controller” may refer to a hardware device including a memory and a processor. The memory is configured to store program instructions, and the processor is specifically programmed to execute the program instructions to perform one or more processes described in more detail below. A controller may control operations of units, modules, parts, devices, or similar thereto, as described herein. It is also understood that the methods below may be performed by a device including a controller along with one or more other components, as will be appreciated by those skilled in the art.

Throughout the specification, a “function” means a function of an infotainment terminal unless otherwise specifically stated, and is understood to include program and data for implementing the function.

Hereinafter, an over-the-air (OTA) service system for vehicles and a method thereof will be described in detail with reference to the accompanying drawings.

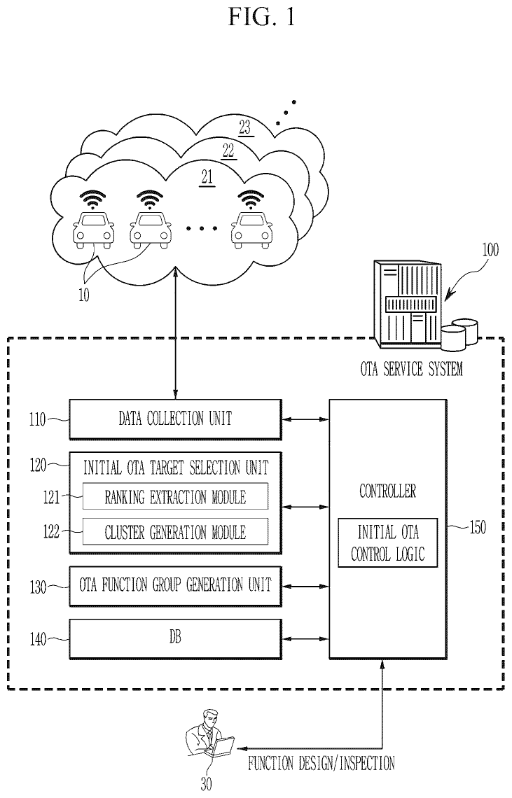

FIG. 1 is a block diagram showing the configuration of an example OTA service system for vehicles.

Referring to FIG. 1, an OTA service system 100 for vehicles 10 may include a data collection unit 110, an initial OTA target selection unit 120, an OTA function group generation unit 130, a database (DB) 140, and a controller 150. One or more components of the OTA service system 100 (e.g., the data collection unit 110, the initial OTA target selection unit 120, the OTA function group generation unit 130, the database (DB) 140, the controller 150, etc.) may be implemented as software (e.g., computer-readable instructions, software modules, programs, etc.), as hardware (e.g., one or more processors and/or memory), or as a combination of both.

Each of the vehicles 10 is a connected car capable of wireless communication and has an infotainment terminal (hereinafter referred to as infotainment) capable of OTA update mounted thereon.

The data collection unit 110 collects user data (e.g., infotainment system usage data) according to the use (function operation) of an infotainment of the vehicles 10 and stores the user data in the DB 140. The user data may be, for example, historical usage data or patterns (e.g., types of user inputs, timestamps for user inputs, etc.) of one or more users.

The initial OTA target selection unit 120 extracts a user ranking for each administrative district by using the user data and selects an infotainment loyal user cluster with the highest ranking score based on centrality measure.

The OTA function group generation unit 130 generates a plurality of OTA ranking function groups classified according to importance (e.g., priority) in an OTA target function list.

The controller 150 controls the initial OTA according to the order of the OTA ranking function groups by using the loyal user cluster as a target group, monitors the initial OTA progress, and early detects the occurrence of an event.

Hereinafter, the OTA service system 100 according to one or more example embodiments of the present disclosure is described on the assumption of one integrated system, but the present disclosure is not limited thereto, and the respective configurations 110 to 115 may be implemented as independent servers and linked over a network.

The data collection unit 110 collects user data in real time or non-real time (e.g., historical usage data) from the vehicles 10 distributed by administrative districts (also referred to as geographic areas) 21, 22, and 23 and stores the user data in the DB 140.

The data collection unit 110 may analyze the user data, extract at least one of a collection date and time, a customer identifier (ID), a network ID (base station ID), infotainment function log information, and error information, and accumulate a DB in the form of a table.

The initial OTA target selection unit 120 generates (e.g., determine) original variables (e.g., first variables) that are significant for user grouping (e.g., one or more predetermined functionalities that are indicative of an advanced user) as shown in Table 1 below. The original variables are generated with respect to a function (e.g., functionality) that tends to be used only (or more frequently) used by an advanced user (e.g., active user) of the infotainment system (e.g., beyond just general or functionalities). A general functionality (also referred to as a core functionality or a general setting function) may be a functionality of the vehicle infotainment system that, for example, is readily accessible without too much manipulation of a user interface. For example, a general functionality may be available for access at a top level or top layer of a menu in a user interface. Such a user may be considered an active user (also referred to as a power user, an advanced user, or a frequent user) who uses a certain function (e.g., infotainment system) frequently (e.g., more than a threshold amount during a given time period). A user who does not use the function as frequently (e.g., less than a threshold amount during a given time period) may be considered an infrequent user (also referred to as a casual user). The original variables may be associated with advanced functionalities (e.g., one or more functionalities that are designated or predetermined to be advanced functionalities) of the vehicle infotainment system. For example, some functionalities of the vehicle infotainment system may be designated (e.g., predetermined) as a first group of functionalities (e.g., advanced functionalities) and some other functionalities of the vehicle infotainment system may be designated (e.g., predetermined) as a second group of functionalities (e.g., general or non-advanced functionalities).

For example, in the infotainment, the general setting function applied to a vehicle and a sub-option for each function are set as default. In other words, a user interface (UI) of the infotainment has a tree structure in which at least one sub-option setting menu is connected step by step from various general menus for each function set as default. A sub-option setting menu may be a setting that is accessible only through multiple interactions with a menu in a user interface (e.g., buried further down in the menu than a top-level or top-layer menu item).

A user who is not an advanced user of such an infotainment system may mainly use general setting functions without a significant change from the default state (e.g., only use default settings). On the other hand, an advanced user (e.g., active user who uses the vehicle infotainment system more frequently (e.g., more than a threshold amount in a given time period)) of the infotainment system may tend to change a detailed sub-option setting menu rather than the general setting function.

TABLE 1
Examples of original variables significant for user grouping

```
      [original variables]
Map (real time data)
    - Navigation View Options
    - Whether navigation guidance is checked first
Sound (real time data)
    - Advanced Acoustics > Speed Linked Volume Settings Mode
    - Guidance note > Voice change (bright female voice, soft male voice)
- Guidance note > Hi-pass payment amount (no further guidance, amount used
today, amount used this month)
- Guidance note > Navigation warning > Camera warning time (500 m/300 m/100
m in front of general road, 1 km/700 m/300 m in front of the highway)
  - Radio syllables (primary emphasis, primary/noise balance, noise minimization)
  - Voice recognition (selecting an avatar, guide voice minimization in guiding
method)
  - Screen Configuration > Standby Screen (digital frame, clock, no display)
  - Screen Configuration > Number of split screen settings
  - General > Date Time (time display method)
  - General > Keyboard (Korean keyboard type, X, English keyboard type)
- General > Keyboard (automatic execution of dictation by voice)
  - General > SW Information/Update > Use Update Automatic Installation
- Share my car location
      - Car-to-home device
```

In addition, the initial OTA target selection unit 120 generates derivative variables derived from the original variables and significant for user grouping.

The derivative variables are criteria for calculating (e.g., determining) frequency according to the frequency that the user uses a specific function and whether to set personalized detailed options based on user data collected in non-real time or every predetermined period.

TABLE 2
Example of derivative variables significant for user grouping

```
    [derivative variables]
Map (non real-time data)
  - “Dong” to which destinations set in the last 30 days belong
  - Number of destinations set in the last 30 days (excluding redundancy)
EV mode (non real-time data)
  - Number of times utility mode used in the last 30 days
Sound (non real-time data)
  - Seat position setting mode (seat position front>back, front=back,
  front<back)
- Others, etc.
```

The initial OTA target selection unit 120 allocates scores of categorical variable data with respect to the original variables and the derivative variables.

For example, the initial OTA target selection unit 120 performs a ranking-based score allocation first, but when the ranking-based score allocation is not performed, performs a frequency-based score allocation in a score allocation method of the categorical variable data.

The ranking-based score allocation method refers to arranging data in a ranking with respect to categories and giving a ranking to each category. For example, when there are grades such as A, B, C, and D in a categorical variable of “grade,” “A” is given the highest score. Also, “B” may be given the next highest score.

The frequency-based score allocation method is a method of giving scores with respect to the frequency of data belonging to the same category, and the higher the frequency of the category, the higher the score may be allocated. For example, assuming that there are categorical variables called “clock” and “standby screen” in a screen configuration, and “clock” is the most frequently appearing category in the data, a higher score may be allocated to the “clock” than to the “standby screen”.

The initial OTA target selection unit 120 includes a ranking extraction module 121 and a cluster generation module 122 as configurations for selecting an automated initial OTA user cluster.

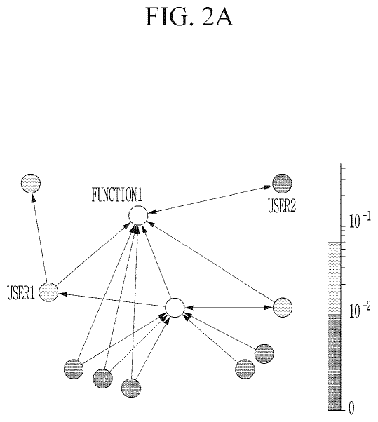

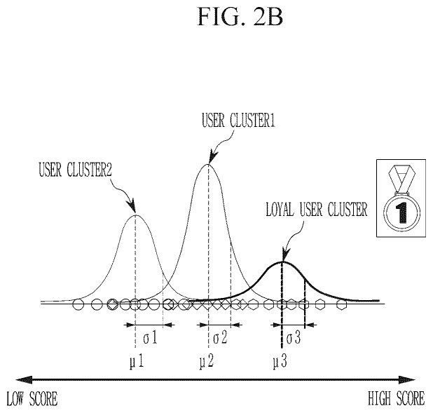

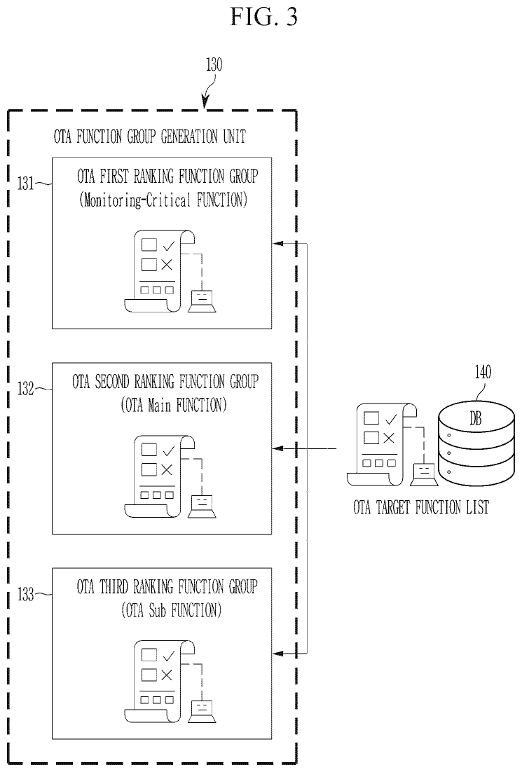

FIGS. 2A and 3B are graphs showing an example process of automated initial OTA user cluster selection.

Referring to FIG. 2A, a user ranking extraction distribution for each administrative district (e.g., geographic area) is shown.

The ranking extraction module 121 uses user data to extract user ranking distributions (user 1, user 2, . . . , user n) according to network centrality-based administrative districts 21, 22, and 23.

The ranking extraction module 121 calculates (e.g., determines) a node size for each of functions of users and a function edge size for each of the users according to the administrative districts such as a city or a province by using the user data in the DB.

At this time, the node for each function of the user may be calculated as a distance driven in the last 30 days/the number of drives in the last 30 days*the number of trips in the last 30 days. The function edge for each user may be calculated as the sum of scores.

The ranking extraction module 121 may calculate (e.g., determine) an importance score with respect to each node based on centrality measure. A user ranking is determined according to the importance score.

At this time, when the number of nodes in an administrative district (e.g., geographic area) is 10,000 or more, the importance score is calculated using (summing) betweenness centrality and eigen centrality. In addition, when the number of nodes in the administrative district is less than 10,000, the importance score is calculated using (summing) degree centrality, betweenness centrality and eigen centrality

Here, the individual centrality may perform data normalization before summation. In addition, the criterion for the number of nodes within the administrative district is arbitrarily set to 10,000, but is not limited thereto, and may be replaced with an intermediate value in the distribution of the entire number of nodes in the administrative district.

The cluster generation module 122 selects an infotainment loyal user cluster by analyzing the user ranking distributions according to the administrative districts through a Gaussian mixture model (GMM).

The cluster generation module 122 may calculate (e.g., determine) a user cluster by using GMM modeling by performing Min-Max Normalization (Min: 0, Max: 100) on the user distribution for each administrative district based on the importance score calculated through the ranking extraction module 121.

Referring to FIG. 2B, an infotainment loyal customer cluster selection method is shown.

Several user clusters may be derived in the order of a loyal user cluster, a user cluster 1, and a user cluster 2 according to the size of the importance score from the entire user distribution.

The cluster generation module 122 selects a user cluster having the greatest importance (e.g., the highest score) in the entire user distribution as an “infotainment loyal user cluster” (also referred to as a priority user group).

The infotainment loyal user cluster may be defined as a zero-ranked user cluster having a high understanding of the functions of the infotainment system, active in setting (e.g., adjusting) a power-user function, and high frequency of use of several functions.

The initial OTA target selection unit 120 selects the infotainment loyal user cluster as an initial OTA target group and transfers the initial OTA target group to the controller 150.

FIG. 3 is a block diagram showing a configuration of an example OTA function group generation unit.

Referring to FIG. 3, the OTA function group generation unit 130 may generate a plurality of OTA ranking function groups (e.g., a plurality of ranked functionalities of the infotainment system to be updated OTA) classified according to importance (e.g., priority) in an OTA target function list extracted from the DB 140.

The OTA function group generation unit 130 groups OTA function rankings by applying automated logic, for this purpose, defines the name of infotainment for each function, related data, and related function list in advance, and utilizes a specification for each function.

For example, the OTA function group generation unit 130 may generate an OTA first ranking function group 131 grouped with a monitoring-critical function, an OTA second ranking function group 132 grouped with an OTA main function, and an OTA third ranking function group 133 grouped with an OTA sub function in the entire OTA target function list.

The monitoring-critical function corresponding to the OTA first ranking function group 131 includes a function (one or more functionalities) that directly utilizes or changes data related to (e.g., data that affects) vehicle driving safety. For example, the monitoring-critical function may be a vehicle driver assistance device (ex: driving convenience, speed limit, warning notification, etc.), a vehicle drive mode (ex: brake setting, neutral driving mode, etc.), navigation display information, cluster information, etc.

The OTA main function group corresponding to the OTA second ranking function group 132 includes 10 or more related data, or a navigation, cluster, and HUD of infotainment among related functions. In addition, a function a year after the most recent update may be classified into the OTA main function group.

The OTA sub function corresponding to the OTA third ranking function group 133 is classified as the remainder that does not correspond to the OTA first ranking function group 131 and the OTA second ranking function group 132 in the OTA target function list.

The DB 140 may store program and data for operation of the OTA service system 100 for vehicles, and store data generated according to the operation.

For example, the DB 140 stores the DB user data accumulated by the data collection unit 110.

In addition, the DB 140 stores customer's (e.g., user's) registration information, vehicle type and specification, infotainment version, and OTA target function list and its program.

In addition, the DB 140 matches and stores the initial OTA target, the OTA first ranking function group 131, the OTA second ranking function group 132, and the OTA third ranking function group 133 generated by the initial OTA target selection unit 120 and the OTA function group generation unit 130.

The controller 150 may control the overall operation of each of the units 110 to 140 for providing an automated initial OTA service.

The controller 150 may collect an OTA target function through an operator terminal 30, store the OTA target function in the DB 140, if necessary, modify, add, or delete the OTA target function through the inspection of the OTA target function.

The controller 150 performs the initial OTA according to the importance of function on some initial OTA target groups classified as loyal user clusters by using infotainment use data of the customer vehicle 10, monitors the initial OTA state, and early determines whether an event has occurred.

During the initial OTA performed through the OTA function group generation unit 130, the controller 150 sequentially performs a first initial OTA on the OTA first ranking function group 131 grouped with the monitoring-critical function, a second initial OTA on the OTA second ranking function group 132 grouped with the OTA main function, and a third initial OTA on the OTA third ranking function group 133 grouped with the OTA sub function. Here, the OTA first ranking function group 131 may correspond to a case where the monitoring-critical function does not affect driving safety data and a log is normally loaded. In addition, the OTA second ranking function group 132 may correspond to a case where the OTA main function does not affect the driving safety data and the log is normally loaded. In addition, the OTA third ranking function group 133 may correspond to a case where the OTA sub function does not affect the driving safety data and the log is normally loaded.

At this time, when an error event occurs in any one OTA ranking function group 131, 132, or 133 during the initial OTA, the controller 150 may immediately give an alarm to the operator terminal 30 and perform re-inspection on the corresponding function.

On the other hand, when normal updates of all the groups 131, 132, and 133 are completed without an event during the initial OTA, the controller 150 may determine that the actual verification of the OTA target function list has been completed.

The controller 150 may be implemented as one or more processors operating by a set program, and the set program may be programmed to perform each step of an OTA service method for vehicles.

The OTA service method for vehicles is described in more detail with reference to the drawings below.

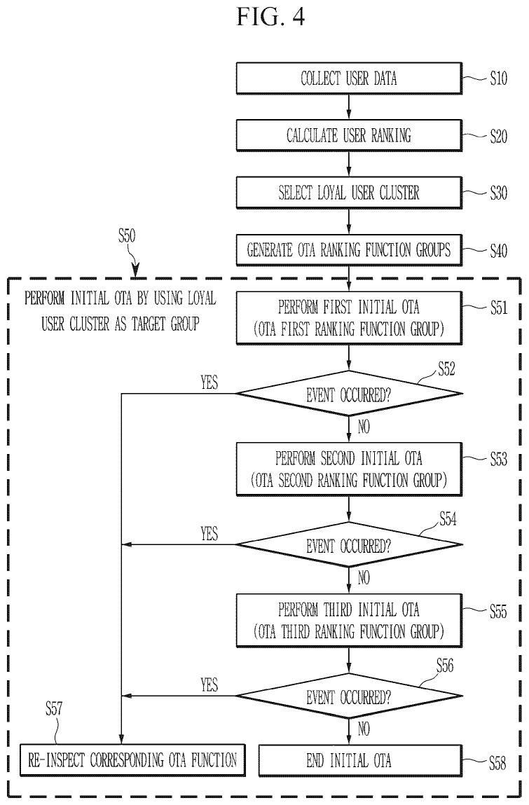

FIG. 4 is a flowchart showing an example OTA service method for vehicles.

Referring to FIG. 4, the controller 150 of the OTA service system 100 may collect user data in real time or non-real time from vehicles distributed based on administrative districts (S10).

At this time, the controller 150 may extract at least one of a collection (e.g., data collection) date and time, customer (e.g., user) ID, network ID (base station ID), infotainment log information, and error information from the user data and make a DB in the form of a table.

The controller 150 may calculate (e.g., determine) a user ranking according to an importance score for each administrative district by using the user data (S20).

The controller 150 classifies a plurality of user cluster rankings according to the user ranking and selects an infotainment loyal user cluster with the highest score among the entire user distributions (S30).

The controller 150 generates a plurality of OTA ranking function groups classified according to importance in an OTA target function list (S40). For example, the controller 150 may generate the OTA first ranking function group 131 grouped with a monitoring-critical function, the OTA second ranking function group 132 grouped with an OTA main function, and the OTA third ranking function group 133 grouped with an OTA sub function in the OTA target function list.

The controller 150 controls the initial OTA by using the loyal user cluster as a target group (S50).

At this time, the controller 150 may sequentially perform updates of the OTA first ranking function group 131 grouped with the monitoring-critical function, the OTA second ranking function group 132 grouped with the OTA main function, and the OTA third ranking function group 133 grouped with the OTA sub function by using the loyal user cluster as the target group.

For example, the controller 150 performs a first initial OTA for updating the OTA first ranking function group 131 grouped with the monitoring-critical function by using the loyal user cluster as the target group (S51).

The controller 150 monitors a first initial OTA progress to determine whether an event has occurred (S52).

At this time, when the monitoring-critical function affects driving safety data or an event occurs in which no log is normally loaded (S52; Yes), the controller 150 re-inspects the corresponding OTA function (S57).

On the other hand, when the event does not occur (S52; No), the controller 150 completes the first initial OTA.

The controller 150 performs a second initial OTA for updating the OTA second ranking function group 132 grouped with the OTA main function by using the loyal user cluster as the target group (S53).

The controller 150 monitors a second initial OTA progress to determine whether an event has occurred (S54).

At this time, when the OTA main function affects the driving safety data or the event in which no log is normally loaded occurs (S54; Yes), the controller 150 re-inspects the corresponding OTA function (S57).

On the other hand, when the event does not occur (S54; No), the controller 150 completes the second initial OTA.

The controller 150 performs a third initial OTA for updating the OTA third ranking function group 133 grouped with the OTA sub function by using the loyal user cluster as the target group (S55).

The controller 150 monitors a third initial OTA progress to determine whether an event has occurred (S56).

At this time, when the OTA sub function affects the driving safety data or the event in which no log is normally loaded occurs (S56; Yes), the controller 150 re-inspects the corresponding OTA function (S57).

On the other hand, when the event does not occur (S56; No), the controller 150 completes the third initial OTA, and ends the initial OTA (S58).

In step S57, the controller 150 may transmit (alarm) the corresponding re-inspection event to the operator terminal 30, and then retry the corresponding initial OTA when the re-inspection is completed.

In addition, when the initial OTA ends, the controller 150 determines that the actual verification of the OTA target function list has been completed and may perform an OTA on the remaining user clusters.

At this time, the controller 150 may perform sequential OTA in the order of user cluster 1 and user cluster 2 set according to the size of the importance score.

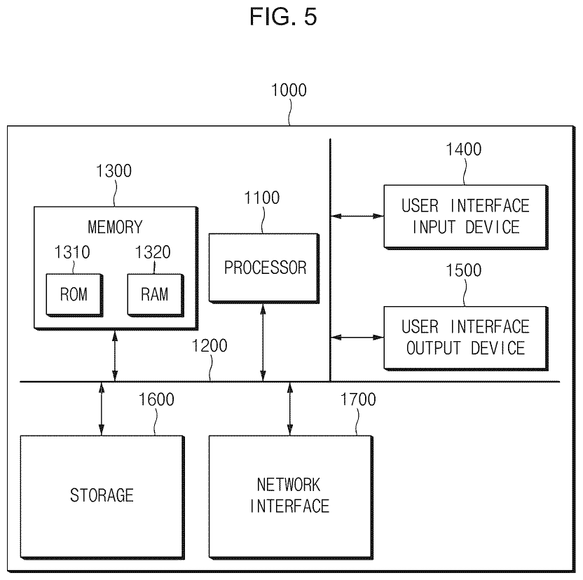

FIG. 5 shows an example computing system (e.g., a computing device of a vehicle or any other apparatus). One or more controllers, processors, etc. described herein may be implemented by the computing system or may be implemented in the computing system. For example, one or more of the vehicles 10, the OTA service system 100, any component of the OTA service system 100, OTA function group generation unit 130, the OTA target function list 140, etc. may be implemented with a computing system 1000 as shown in FIG. 5.

The computing system (also referred as a computer, a computing device, etc.) 1000 may include at least one processor 1100, memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random access memory (RAM).

Communication interface(s) (also referred to as communication device(s), communicator(s), communication module(s), communication unit(s), etc.), such as the network interface 1700, may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

Accordingly, the operations of the method or algorithm described in connection with example embodiment(s) disclosed in the specification may be directly implemented with a hardware module, a software module, or a combination of the hardware module and the software module, which is executed by the processor 1100. The software module may reside on a storage medium (i.e., the memory 1300 and/or the storage 1600) such as RAM, a flash memory, ROM, an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

An over-the-air (OTA) service system according to an aspect of the present disclosure includes a data collection unit configured to collect user data according to use of an infotainment of the vehicles and store the user data in a database (DB), an initial OTA target selection unit configured to extract a user ranking for each administrative district by using the user data and select an infotainment loyal user cluster with a highest ranking score based on centrality measure, an OTA function group generation unit configured to generate a plurality of OTA ranking function groups classified according to an importance of each function in an OTA target function list, and a controller configured to control an initial OTA according to the order of the OTA ranking function groups by using the loyal user cluster as a target group, monitor an initial OTA progress, and early detect an occurrence of an event.

The data collection unit may analyze the user data, extract at least one of a collection date and time, a customer ID, a network ID, infotainment function log information, and error information, and accumulate a DB in the form of a table.

The initial OTA target selection unit may generate original variables with respect to a function which is considered to sensitively use the infotainment and generate derivative variables derived from the original variables and significant for user grouping.

The initial OTA target selection unit may allocate scores of categorical variable data with respect to the original variables and the derivative variables.

In a method of allocating the scores of categorical variable data, a ranking-based score allocation may be performed first with respect to the original variables and the derivative variables, but when the ranking-based score allocation is not performed, a frequency-based score allocation may be performed.

The initial OTA target selection unit may include a ranking extraction module configured to extract user ranking distributions according to network centrality-based administrative districts by using the user data, and a cluster generation module configured to select the infotainment loyal user cluster by analyzing the user ranking for each administrative district through a Gaussian mixture model (GMM).

The ranking extraction module may calculate a node size for each of functions of users and a function edge size for each of the users according to the administrative districts by using the user data, and calculate an importance score with respect to each node based on centrality measure.

The cluster generation module may select the infotainment loyal user cluster as an initial OTA target group and transfer the initial OTA target group to the controller.

The OTA function group generation unit may include an OTA first ranking function group grouped with a monitoring-critical function, an OTA second ranking function group grouped with an OTA main function, and an OTA third ranking function group grouped with an OTA sub function in the OTA target function list.

The controller may sequentially, during the initial OTA, perform a first initial OTA on the OTA first ranking function group grouped with the monitoring-critical function, perform a second initial OTA on the OTA second ranking function group grouped with the OTA main function, and perform a third initial OTA on the OTA third ranking function group grouped with the OTA sub function.

The controller may immediately give an alarm to an engineer and perform re-inspection on the corresponding function when an error event occurs in any one OTA ranking function group during the initial OTA.

An OTA service method for vehicles according to an aspect of the present disclosure includes collecting user data according to use of an infotainment of the vehicles and storing the user data in a DB, calculating a user ranking according to an importance score for each administrative district by using the user data, classifying a plurality of user cluster rankings according to the user ranking and selecting an infotainment loyal user cluster with a highest score among entire user distributions, generating a plurality of OTA ranking function groups classified according to an importance for each function in an OTA target function list, and controlling an initial OTA according to the order of the OTA ranking function groups by using the loyal user cluster as a target group, monitoring an initial OTA progress, and early detecting an occurrence of an event.

The generating of the plurality of OTA ranking function groups may include generating an OTA first ranking function group grouped with a monitoring-critical function, an OTA second ranking function group grouped with an OTA main function, and an OTA third ranking function group grouped with an OTA sub function in the OTA target function list.

The early detecting of the occurrence of the event may include performing a first initial OTA for updating the OTA first ranking function group grouped with the monitoring-critical function by using the loyal user cluster as a target group, monitoring a first initial OTA progress and determining whether the event has occurred, and when the monitoring-critical function affects driving safety data or an event occurs in which no log is normally loaded, re-inspecting the corresponding OTA function.

The OTA service method may further include, after completing the first initial OTA without an occurrence of the event, performing a second initial OTA for updating the OTA second ranking function group grouped with the OTA main function by using the loyal user cluster as the target group, monitoring a second initial OTA progress and determining whether an event has occurred, and when the OTA main function affects driving safety data or an event occurs in which no log is normally loaded, re-inspecting the corresponding OTA function.

The OTA service method may further include, after completing the second initial OTA without the occurrence of the event, performing a third initial OTA for updating the OTA third ranking function group grouped with the OTA sub function by using the loyal user cluster as the target group, monitoring a third initial OTA progress and determining whether an event has occurred, and when the OTA sub function affects the driving safety data or the event occurs in which no log is normally loaded, re-inspecting the corresponding OTA function.

The determining of whether the event has occurred may include, when the event does not occur, completing the third initial OTA, and ending the initial OTA, and determining that an actual verification of the OTA target function list has been completed and performing an OTA on remaining user clusters.

As described herein, the stable OTA service may be provided by performing the initial OTA by using a loyal user cluster that has a high understanding of the function of vehicle infotainment and actively uses the function as a target group, and early determining an event occurrence situation through monitoring.

In addition, the trial and error may be reduced and customer satisfaction may be improved when actually performing OTA by first providing an OTA update to a selected infotainment loyal user cluster and checking feedback accordingly.

In addition, the event occurrence time and range required for re-examination may be specified by dividing an OTA target function list into a plurality of OTA ranking function groups according to importance and sequentially performing the initial OTA.

The one or more example embodiments of the present disclosure are not implemented only through the device and/or method described herein, and may also be implemented through a program (e.g., instructions, software, etc.) for realizing a function corresponding to the configuration of the example embodiment(s) of the present disclosure, a recording medium on which the program is recorded, etc., which may be easily implemented by an expert in the technical field to which the present disclosure belongs based on the description of the example embodiment(s) described herein.

Although the example embodiment(s) of the disclosure have been described in detail herein, the scope of the disclosure is not limited thereto, and various modifications and improvements made by those of ordinary skill in the field to which the disclosure pertains also belong to the scope of the disclosure.

What is claimed is:

1. An apparatus for a vehicle, the apparatus comprising:
a processor; and
a memory storing at least one instruction that is configured, when executed by the processor communicating with the memory, to cause the apparatus to:
obtain, from a plurality of vehicles, usage data indicating historical usage patterns, by a plurality of users, of vehicle infotainment systems of the plurality of vehicles;
store, in a database, the usage data;
determine, based on the usage data, user rankings, for each of a plurality of geographic areas, of the plurality of users;
determine a priority user group comprising users, of the plurality of users, having highest user rankings based on centrality measure;
determine a plurality of ranked functionalities of the vehicle infotainment systems to be updated over-the-air (OTA), wherein the plurality of ranked functionalities are ranked based on priority;
perform, in order of the plurality of ranked functionalities, initial OTA updates on vehicle infotainment systems of a first group of vehicles, of the plurality of vehicles, that are associated with the priority user group; and
monitor the first group of vehicles for occurrence of an error event.

2. The apparatus of claim 1, wherein the at least one instruction is configured, when executed by the processor communicating with the memory, to cause the apparatus to store the usage data by:
obtaining, based on the usage data, at least one of: a data collection date, a data collection time, a user identifier, a network identifier, vehicle infotainment system functionality log information, or error information; and
updating, based on the usage data, a table in the database.

3. The apparatus of claim 1, wherein the at least one instruction is configured, when executed by the processor communicating with the memory, to cause the apparatus to determine the priority user group by:
determining a first group of functionalities of the vehicle infotainment systems and a second group of functionalities of the vehicle infotainment systems.

4. The apparatus of claim 3, wherein the at least one instruction is configured, when executed by the processor communicating with the memory, to cause the apparatus to determine the priority user group by:
allocating scores of categorical variable data with respect to the first group of functionalities and the second group of functionalities.

5. The apparatus of claim 4, wherein the at least one instruction is configured, when executed by the processor communicating with the memory, to cause the apparatus to allocate the scores by one of:
performing a ranking-based score allocation with respect to the first group of functionalities and the second group of functionalities, or
performing a frequency-based score allocation.

6. The apparatus of claim 1, wherein the at least one instruction is configured, when executed by the processor communicating with the memory, to cause the apparatus to determine the priority user group by:
determining, based on the usage data, user ranking distributions according to network centrality-based geographic areas; and
analyzing, based on a Gaussian mixture model (GMM), the user rankings for each of the plurality of geographic areas.

7. The apparatus of claim 6, wherein the at least one instruction is configured, when executed by the processor communicating with the memory, to cause the apparatus to determine the priority user group by:
determining, based on the usage data, a node size for each of functions of the plurality of users and a function edge size for each of the plurality of users according to the plurality of geographic areas; and
determining an importance score with respect to each node based on centrality measure.

8. The apparatus of claim 6, wherein the at least one instruction is configured, when executed by the processor communicating with the memory, to cause the apparatus to determine the priority user group by:
selecting the priority user group as an initial OTA target group.

9. The apparatus of claim 1, wherein the plurality of ranked functionalities comprise:
a first group of functionalities comprising monitoring-critical functionalities;
a second group of functionalities comprising OTA main functionalities; and
a third group of functionalities comprising OTA sub functionalities.

10. The apparatus of claim 9, wherein the at least one instruction is configured, when executed by the processor communicating with the memory, to cause the apparatus to perform the initial OTA updates by sequentially performing:
a first initial OTA update of the first group of functionalities;
a second initial OTA update of the second group of functionalities; and
a third initial OTA update of the third group of functionalities.

11. The apparatus of claim 1, wherein the at least one instruction is configured, when executed by the processor communicating with the memory, to further cause the apparatus to:
send, based on the occurrence of the error event, a signal to an operator terminal.

12. A method performed by a computing device, the method comprising:
obtaining, from a plurality of vehicles, usage data indicating historical usage patterns, by a plurality of users, of vehicle infotainment systems of the plurality of vehicles;
storing, in a database, the usage data;
determining, based on the usage data, user rankings, for each of a plurality of geographic areas, of the plurality of users;
determining a priority user group comprising users, of the plurality of users, having highest user rankings based on centrality measure;
determining a plurality of ranked functionalities of the vehicle infotainment systems to be updated over-the-air (OTA), wherein the plurality of ranked functionalities are ranked based on priority;
performing, in order of the plurality of ranked functionalities, initial OTA updates on vehicle infotainment systems of a first group of vehicles, of the plurality of vehicles, that are associated with the priority user group; and
monitoring the first group of vehicles for an occurrence of an error event.

13. The method of claim 12, wherein the plurality of ranked functionalities comprise:
a first group of functionalities comprising monitoring-critical functionalities;
a second group of functionalities comprising OTA main functionalities; and
a third group of functionalities comprising OTA sub functionalities.

14. The method of claim 13, wherein the monitoring of the first group of vehicles comprises:
performing a first initial OTA update of the first group of functionalities by using the priority user group as a target group;
monitoring the first initial OTA update and determining whether the error event has occurred; and
based on the monitoring-critical functionalities affecting driving safety data or no log being loaded, re-inspecting a corresponding OTA functionality.

15. The method of claim 14, further comprising, after completing the first initial OTA update without the occurrence of the error event:
performing a second initial OTA update of the second group of functionalities by using the priority user group as the target group;
monitoring the second initial OTA update and determining whether the error event has occurred; and
based on the OTA main functionalities affecting the driving safety data or no log being loaded, re-inspecting the corresponding OTA functionality.

16. The method of claim 15, further comprising, after completing the second initial OTA update without the occurrence of the error event:
performing a third initial OTA update of the third group of functionalities by using the priority user group as the target group;
monitoring the third initial OTA update and determining whether the error event has occurred; and
based on the OTA sub functionalities affecting the driving safety data or no log being loaded, re-inspecting the corresponding OTA functionality.

17. The method of claim 16, further comprising determining whether the error event has occurred by:
based on the error event not occurring, completing the third initial OTA update and ending the initial OTA; and
determining that a verification of the plurality of ranked functionalities has been completed and performing an OTA update on remaining users of the plurality of users.
